(19) United States
(12) Patent Application Publication
(10) Pub. No.: US 2008/0068860 A1
(43) Pub. Date: Mar. 20, 2008

(54) BACKLIGHT MODULE

(75) Inventors: Chung Peng, Hsinchu (TW); Chih-Kuang Chen, Hsinchu (TW); Shin-Chin Tseng, Hsinchu (TW); Yu-Kai Lin, Hsinchu (TW); Shen-Hong Chou, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/759,318

(22) Filed: Jun. 7, 2007

(30) Foreign Application Priority Data
Sep. 18, 2006 (TW) 95134433

(51) Int. Cl. F21V 8/00; F21V 7/00

(52) U.S. Cl. 362/612; 362/613

(57) ABSTRACT

A backlight module comprises a housing, a first emitting unit, a second emitting unit and a light stopper. The housing comprises a reflective surface. The first emitting unit is disposed on the reflective surface, providing a first light beam, wherein an angle between the first light beam and the reflective surface is between 0° and −90°. The second emitting unit is disposed on the reflective surface, providing a second light beam, wherein an angle between the second light beam and the reflective surface is between 0° and −90°. The light stopper is disposed on the reflective surface between the first emitting unit and the second emitting unit.

### BACKGROUND OF THE INVENTION

1. Field of the Invention

The invention relates to a backlight module, and in particular to a backlight module controlling brightness of separated areas in real time.

2. Description of the Related Art

FIG. 1 shows a conventional backlight module utilizing side emitting diodes, comprising an optical sheet 1, a housing 2, and a plurality of side emitting units 3. Housing 2 comprises a reflective surface S formed thereon. Conventionally, light beams 4 from side emitting units 3 travel horizontally or toward the bottom of reflective surface S. Thus, before emission from optical sheet 1, light beams 4 are reflected by reflective surface S.

Conventionally, light beams 4 from each side emitting unit 3 cover a wider emission area. Therefore, backlight module 10 cannot control brightness of separated areas thereof in real time to provide high contrast image.

### BRIEF SUMMARY OF THE INVENTION

A detailed description is given in the following embodiments with reference to the accompanying drawings.

A backlight module comprises a housing, a first emitting unit, a second emitting unit, and a light stopper. The housing comprises a reflective surface. The first emitting unit is disposed on the reflective surface, providing a first light beam, wherein an angle between the first light beam and the reflective surface is between 0° and −90°. The second emitting unit is disposed on the reflective surface, providing a second light beam, wherein an angle between the second light beam and the reflective surface is between 0° and −90°. The light stopper is disposed on the reflective surface between the first emitting unit and the second emitting unit.

The embodiment utilizes side emitting units providing light beams. Thus, the number of light emitting units required is reduced. Additionally, the embodiment separates the side emitting units (for example, the first emitting unit and the second emitting unit) by light stoppers, and light beams from different light emitting units are not complemented or interfered with. In the embodiment, the backlight module controls the brightness of the first emitting unit and the second emitting unit providing the first light beam and the second light beam separately. Thus, the embodiment controls brightness of separated areas of the backlight module in real time to provide high contrast image.

### BRIEF DESCRIPTION OF THE DRAWINGS

The invention can be more fully understood by reading the subsequent detailed description and examples with references made to the accompanying drawings, wherein:

FIG. 1 shows a conventional backlight module utilizing side emitting diodes;

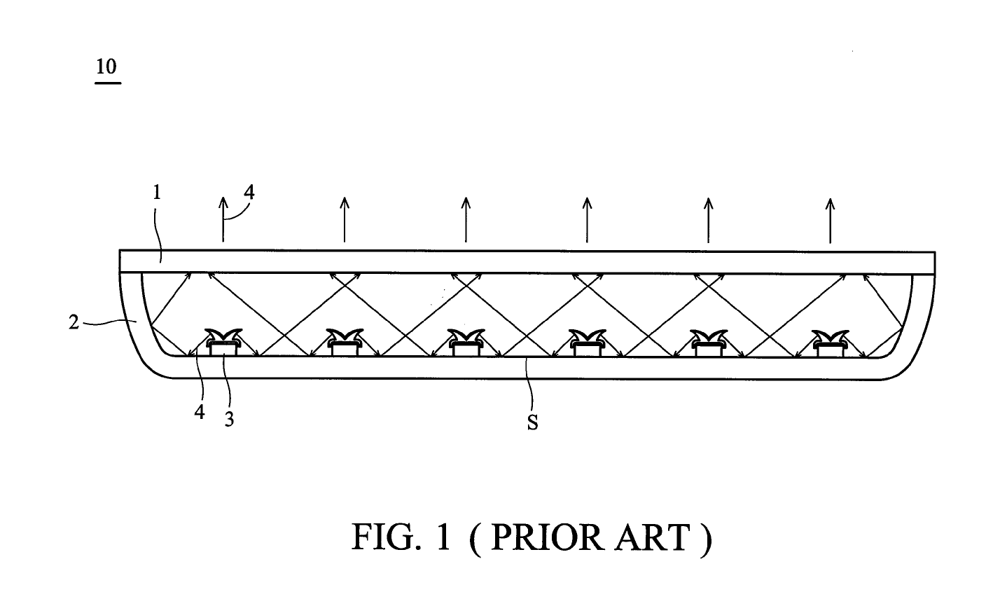

FIG. 2a shows a backlight module of a first embodiment;

FIG. 2b shows detailed structure of a first emitting unit;

FIG. 2c is an enlarged view of portion A of FIG. 2a;

FIG. 3 shows a relationship between the gap and image contrast;

FIG. 4a shows a backlight module of a second embodiment;

FIG. 4b is a top view of the backlight module of the second embodiment; and

FIG. 4c shows a backlight module of a third embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

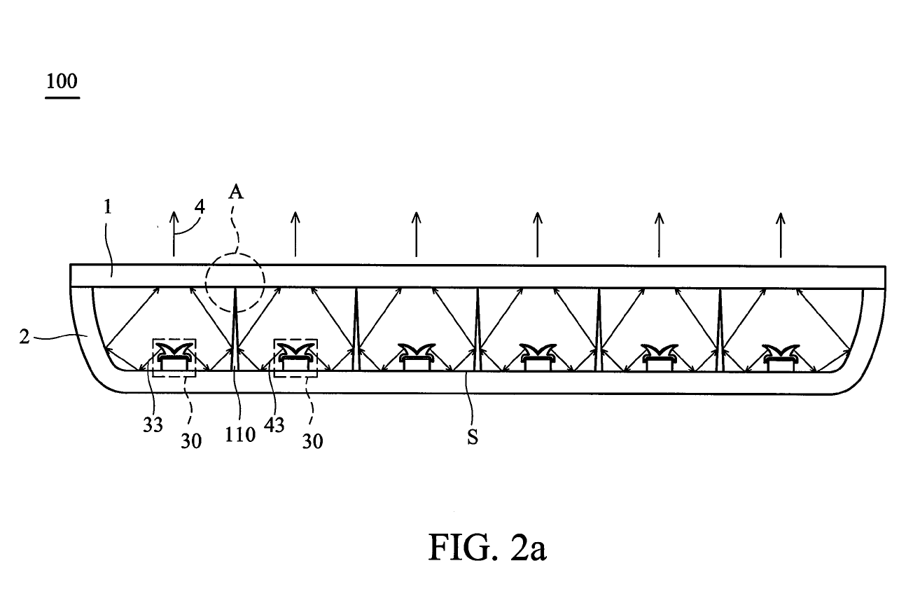

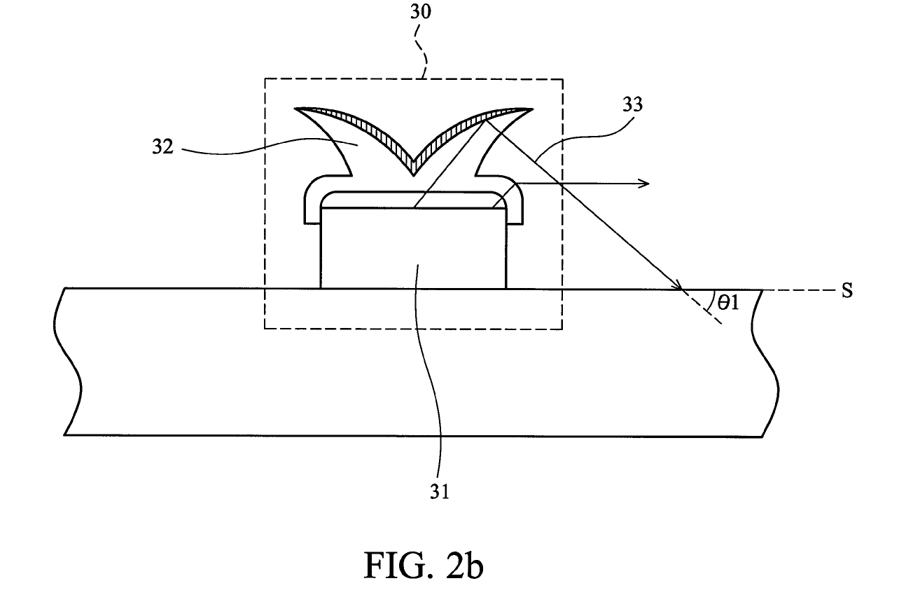

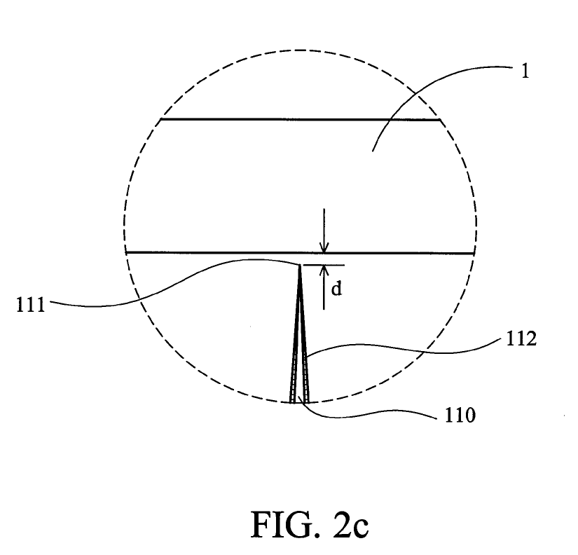

FIG. 2a shows a backlight module 100 of a first embodiment, comprising an optical sheet 1, a housing 2, a plurality of side emitting units (in the following description, a first emitting unit 30 and a second emitting unit 40 represent all side emitting units to simplify description), and a plurality of light stoppers 110. The housing 2 comprises a reflective surface S formed thereon, and the optical sheet 1 is a diffuser or a polarizing sheet.

FIG. 2b shows detailed structure of the first emitting unit 30, comprising a light emitting diode 31 and a light guide element 32. The light emitting diode 31 is a white light emitting diode. The light emitting diode 31 emits a first light beam 33 toward the light guide element 32 which diverts the light path thereof, and an angle θ1 between the first light beam 33 and the reflective surface S is between 0° and −90°. The first light beam 33 is concentrated in directions within the angle θ1 relative to the reflective surface S. In a modified embodiment, the first light beam 33 is more concentrated in directions within the angle θ1 between −5° and −90°. In another modified embodiment, the first light beam 33 is more concentrated in directions within the angle θ1 between −10° and −90°.

Similar to the first emitting unit, the second emitting unit provides a second light beam, and an angle between the second light beam and the reflective surface is between 0° and −90°.

FIG. 2c is an enlarged view of portion A of FIG. 2a, wherein the light stopper 110 comprises a free end 111 and a reflective material 112. The reflective material 112 is coated on a surface of the light stopper 110. A gap d is formed between the free end 111 and optical sheet 1. The gap d is between 0 mm and 4 mm. When gap d is 0 mm, the free end 111 contacts the optical sheet 1.

With reference to FIG. 2a, the embodiment utilizes side emitting units providing light beams. Thus, the number of light emitting units required is reduced. Additionally, the embodiment separates the side emitting units (for example, the first emitting unit 30 and the second emitting unit 40) by light stoppers 110, and light beams from different light emitting units are not complement or interference. In the embodiment, the backlight module 100 controls the brightness of the first emitting unit 30 and the second emitting unit 40 providing the first light beam 33 and the second light beam 43 separately. Thus, the embodiment controls brightness of separated areas of the backlight module 100 in real time to provide high contrast image.

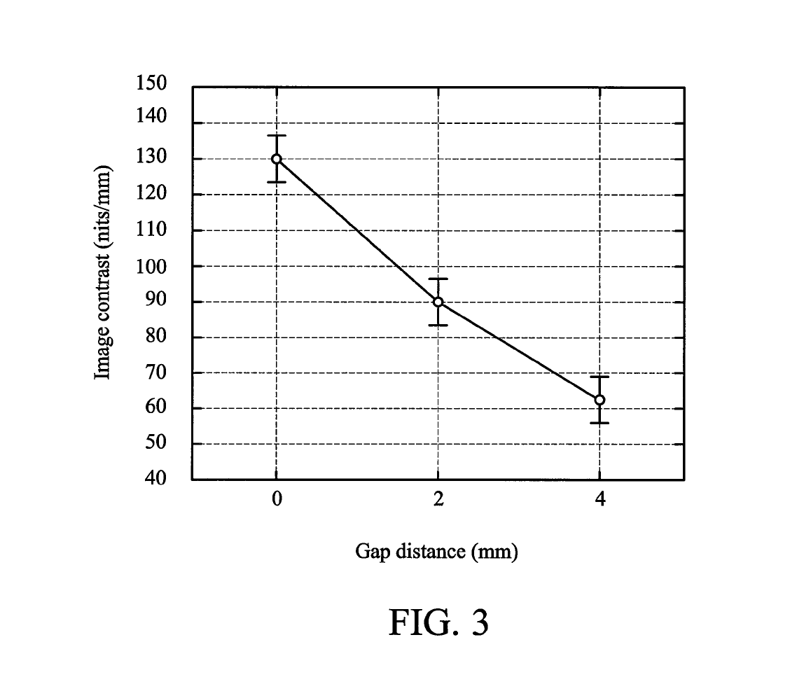

FIG. 3 shows a relationship between the gap d and image contrast. When the gap d is between 0 mm and 4 mm, the backlight module provides improved image contrast. Particularly, when the gap d equals 0 mm, the backlight module provides optimum contrast.

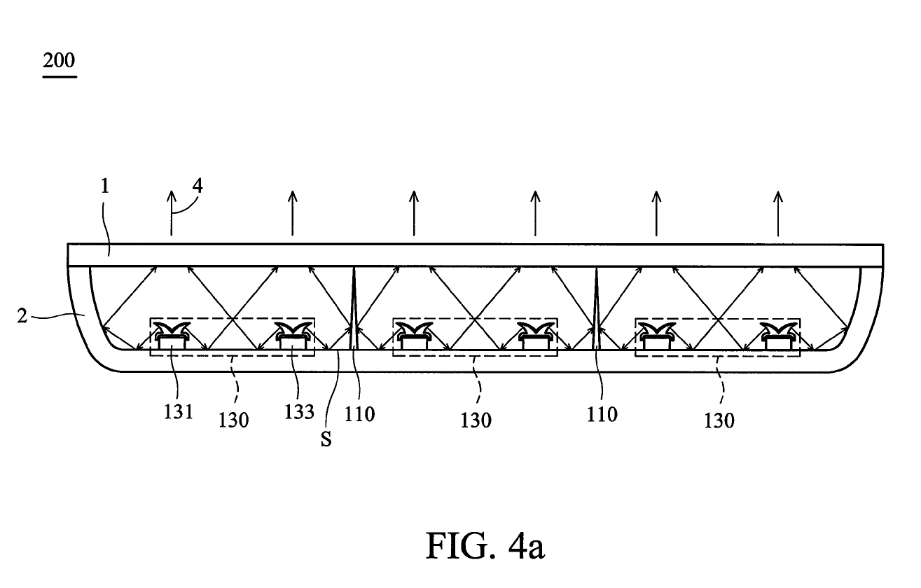

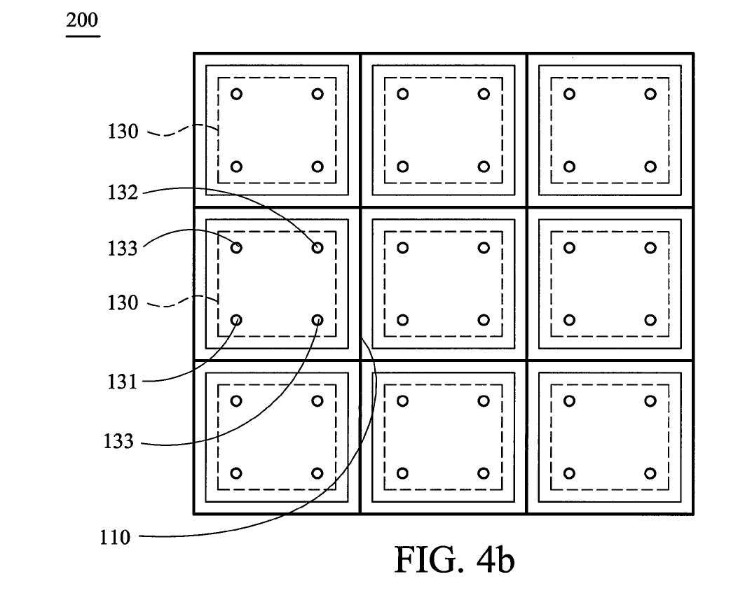

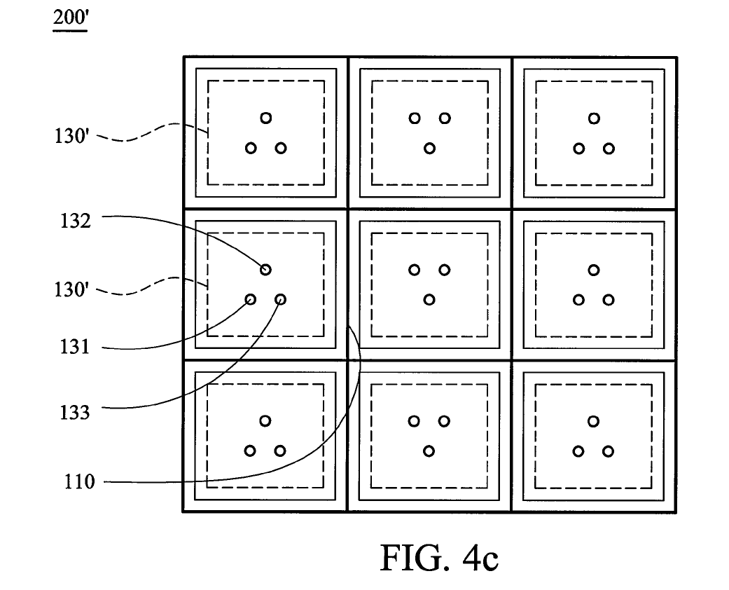

FIG. 4a shows a backlight module 200 of a second embodiment, comprising a plurality of light emitting units 130 arranged in a matrix, with brightness thereof controlled separately. Each light emitting unit 130 comprises a plurality of light emitting diodes and light guide elements. With reference to FIG. 4b, a top view of the backlight module 200, each light emitting unit 130 comprises a blue light emitting set 131, a red light emitting set 132 and two green light emitting sets 133. The blue light emitting set 131, the red light emitting set 132 and the green light emitting sets 133 are arranged in a rectangle, and the green light emitting sets 133 are located on diagonal angles thereof.

FIG. 4c shows a backlight module 200′ of a third embodiment comprising a plurality of light emitting units 130′ arranged in a matrix. Each light emitting unit 130′ comprises a blue light emitting set 131, a red light emitting set 132 and a green light emitting set 133. The blue light emitting set 131, the red light emitting set 132 and the green light emitting sets 133 are arranged in a triangle. In a modified embodiment, the blue light emitting set 131, the red light emitting set 132 and the green light emitting sets 133 can be aligned on a straight line.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising
a housing, comprising a reflective surface;
a first emitting unit, disposed on the reflective surface, providing a first light beam, wherein an angle between the first light beam and the reflective surface is between 0° and −90°;
a second emitting unit, disposed on the reflective surface, providing a second light beam, wherein an angle between the second light beam and the reflective surface is between 0° and −90°; and
a light stopper, disposed on the reflective surface between the first emitting unit and the second emitting unit.

2. The backlight module as claimed in claim 1, further comprising an optical sheet, disposed on the housing corresponding to the first and second emitting units, wherein the light stopper comprises a free end contacting the optical sheet.

3. The backlight module as claimed in claim 1, further comprising an optical sheet, disposed on the housing corresponding to the first and second emitting units, wherein the light stopper comprises a free end, a gap is formed between the free end and the optical sheet, and the gap is between 0 mm and 4 mm.

4. The backlight module as claimed in claim 3, wherein the gap is about 2 mm.

5. The backlight module as claimed in claim 3, wherein the light stopper comprises a reflective material coated on a surface thereof.

6. The backlight module as claimed in claim 2, wherein the light stopper comprises a reflective material coated on a surface thereof.

7. The backlight module as claimed in claim 1, wherein the angle between the first light beam and the reflective surface is between −5° and −90°, and the angle between the second light beam and the reflective surface is between −5° and −90°.

8. The backlight module as claimed in claim 1, wherein the angle between the first light beam and the reflective surface is between −10° and −90°, and the angle between the second light beam and the reflective surface is between −10° and −90°.

9. The backlight module as claimed in claim 1, wherein the first emitting unit comprises a red light emitting set, a blue light emitting set and a green light emitting set.

10. The backlight module as claimed in claim 9, wherein the red light emitting set, the blue light emitting set and the green light emitting set are arranged in a triangle

11. The backlight module as claimed in claim 9, wherein the red light emitting set, the blue light emitting set and the green light emitting set are aligned in a straight line.

12. The backlight module as claimed in claim 1, wherein the first emitting unit comprises a red light emitting set, a blue light emitting set and two green light emitting sets.

13. The backlight module as claimed in claim 12, wherein the red light emitting set, the blue light emitting set and the green light emitting sets are arranged in a rectangle.

14. The backlight module as claimed in claim 13, wherein the green light emitting sets are located on diagonal angles thereof.

15. The backlight module as claimed in claim 12, wherein the red light emitting set, the blue light emitting set and the green light emitting sets are aligned in a straight line.

16. The backlight module as claimed in claim 1, wherein the second emitting unit comprises a red light emitting set, a blue light emitting set and a green light emitting set.

17. The backlight module as claimed in claim 16, wherein the red light emitting set, the blue light emitting set and the green light emitting set are arranged in a triangle

18. The backlight module as claimed in claim 16, wherein the red light emitting set, the blue light emitting set and the green light emitting set are aligned in a straight line.

19. The backlight module as claimed in claim 1, wherein the second emitting unit comprises a red light emitting set, a blue light emitting set and two green light emitting sets.

20. The backlight module as claimed in claim 19, wherein the red light emitting set, the blue light emitting set and the green light emitting sets are arranged in a rectangle.

21. The backlight module as claimed in claim 20, wherein the green light emitting sets are located on diagonal angles thereof.

22. The backlight module as claimed in claim 19, wherein the red light emitting set, the blue light emitting set and the green light emitting sets are aligned in a straight line.

23. The backlight module as claimed in claim 1, wherein the first emitting unit comprises a light emitting diode and a light guide element, the light emitting diode emits a first light beam toward the light guide element, the light guide element changes a light path of the first light beam, and an angle between the first light beam and the reflective surface is between 0° and −90°.

24. The backlight module as claimed in claim 1, wherein the first emitting unit comprises a plurality of light emitting diodes and light guide elements, each of the light emitting diode emits a first light beam toward each of the light guide elements, the light guide elements change light paths of the first light beams, and an angle between each of the first light beam and the reflective surface is between 0° and −90°.

25. The backlight module as claimed in claim 1, wherein the first and second emitting units are side emitting units.

26. A backlight module, comprising
a housing, comprising a reflective surface;
an optical sheet, disposed on the housing parallel to the reflective surface;
a plurality of light emitting units, arrayed on the reflective surface in a matrix, providing a plurality of light beams, wherein angles between the light beams and the reflective surface is between 0° and −90°; and
a plurality of light stoppers, disposed on the reflective surface separating the light emitting units.

27. The backlight module as claimed in claim 26, wherein the backlight module controls brightness of the light emitting units separately.
